(19) United States
(12) Patent Application Publication
(10) Pub. No.: US 2019/0042479 A1
(43) Pub. Date: Feb. 7, 2019

(54) HEURISTIC AND MACHINE-LEARNING BASED METHODS TO PREVENT FINE-GRAINED CACHE SIDE-CHANNEL ATTACKS

(71) Applicant: Intel Corporation, Santa Clara, CA (US)

(72) Inventors: Abhishek Basak, Hillsboro, OR (US); Li Chen, Hillsboro, OR (US); Ravi Sahita, Portland, OR (US)

(73) Assignee: Intel Corporation, Santa Clara, CA (US)

(21) Appl. No.: 16/024,198

(22) Filed: Jun. 29, 2018

(51) Int. Cl. G06F 12/14; G06F 12/0891; G06F 21/55

(52) U.S. Cl. CPC G06F 12/1425; G06F 12/0891; G06F 2221/034; G06F 2212/1052; G06F 21/554

(57) ABSTRACT

A system may include a processor and a memory, the processor having at least one cache as well as memory access monitoring logic. The cache may include a plurality of sets, each set having a plurality of cache lines. Each cache line includes several bits for storing information. During normal operation, the memory access monitoring logic may monitor for a memory access pattern indicative of a side-channel attack (e.g., an abnormally large number of recent CLFLUSH instructions). Upon detecting a possible side-channel attack, the memory access monitoring logic may implement one of several mitigation policies, such as, for example, restricting execution of CLFLUSH operations. Due to the nature of cache-timing side-channel attacks, this prevention of CLFLUSH may prevent attackers utilizing such attacks from gleaning meaningful information.

### TECHNICAL FIELD

The present disclosure relates to systems and methods for preventing cache side-channel attacks.

### BACKGROUND

Sharing of memory between applications or virtual machines (VMs) is commonplace in computer platforms as it leads to effective utilization of system memory and improves bandwidth requirements, overall system performance and energy/power profiles. This includes memory sections consisting of dynamic, shared libraries, memory mapped files and I/O, common data structures, code sections as well as kernel memory. However recent security research has shown that common shared memory can be advantageously utilized by adversaries to conduct fine-grain cache side-channel attacks and extract critical information, secrets etc.

Side-channel attacks gained widespread notoriety in early 2018. In general, a side-channel attack includes any attack based on information gained from the implementation of a computer system, rather than weaknesses in the implemented algorithm itself. Such side-channel attacks may use timing information, power consumption, electromagnetic leaks or even sound as an extra source of information, that is exploited to obtain information and/or data from the system. For example, “Meltdown” and “Spectre” are two well-known cache side-channel approaches used for information leakage at a cache line granularity (64 B on IA). They are applicable in both x-86/64 and ARM based systems, the two most common CPU architectures.

While the exact methodology between attacks differs, in general attacks such as Meltdown and Spectre enable an attacker process to determine contents of memory that the attacker process is not supposed to be able to access (i.e., secret information). This is typically achieved by an attacker process “tricking” a processor into modifying the cache in a specific manner, the manner depending on the secret information that the attacker process is not supposed to be able to access. An attacker attempting a cache side-channel attack such as Spectre or Meltdown then determines the modified state of the cache by deducing whether data originates from a cached or an un-cached memory location. These deductions rely upon precise timing of events such as load operations. In order to detect changes made to the cache, an attacker typically first sets the cache to a known state. For example, this may include a blank state, i.e., with all cache lines invalid. Thus, any subsequent memory access resulting in changes to the cache (i.e., one or more cache lines containing the attacker's data will be evicted and written to) can be detected by the attacker by determining the state of the cache and comparing it to the previously-known state. Therefore, changes made to the cache based on secret information can be interpreted and the secret information can be extracted.

With increased static and run time hardening of the underlying compute platforms with different security features, these shared-memory-based fine-grained cache side-channel leakages are becoming a core component of an attacker's arsenal. Datacenters and cloud computing platforms, where the main business model is services through efficient sharing of resources, are particularly reliant on shared memory and thus vulnerable to these (and similar) attacks. Currently, the benefits of shared memory from a computing efficiency perspective outweighs any of these potential shortcomings or mal-usages.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example computer system according to several embodiments of the present disclosure;

FIG. 2 illustrates an example computer system according to several embodiments of the present disclosure;

FIG. 3 illustrates operations according to one embodiment of the present disclosure;

FIG. 4 illustrates operations according to one embodiment of the present disclosure; and

FIG. 5 illustrates operations according to one embodiment of the present disclosure.

Although the following Detailed Description will proceed with reference being made to illustrative embodiments, many alternatives, modifications and variations thereof will be apparent to those skilled in the art.

### DETAILED DESCRIPTION

The systems and methods disclosed herein provide detection of several different forms of cache-timing-based side-channel attacks. As a non-limiting example, a system consistent with the present disclosure may include a processor and a memory, the processor having at least one cache as well as memory access monitoring logic. The cache may include a plurality of sets, each set having a plurality of cache lines. Each cache line includes several bits for storing information. During normal operation, the memory access monitoring logic may monitor for a memory access pattern indicative of a side-channel attack (e.g., an abnormally large number of recent CLFLUSH instructions). Upon detecting a possible side-channel attack, the memory access monitoring logic may implement one of several mitigation policies, such as, for example, restricting execution of CLFLUSH operations. Due to the nature of cache-timing side-channel attacks, this prevention of CLFLUSH may prevent attackers utilizing such attacks from gleaning meaningful information.

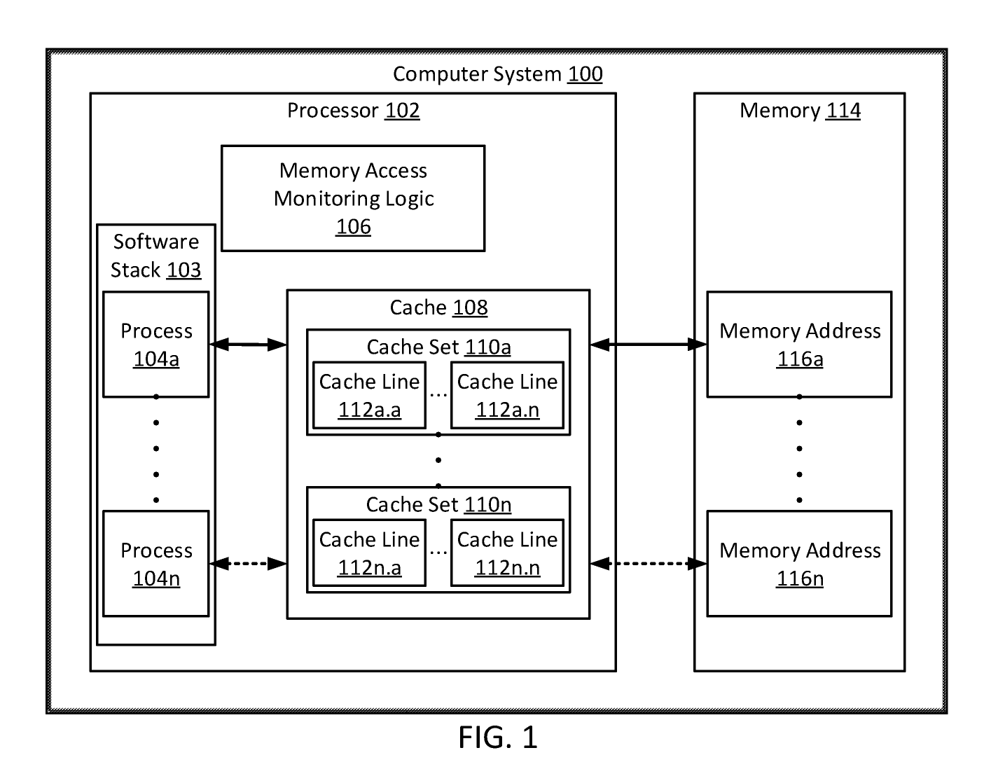

Throughout this disclosure, reference may be made to a “processor” (such as processor 102 in FIG. 1) or “cache” (such as cache 108 in FIG. 1). While many embodiments describe components of this disclosure being located in a single cache of a single processor, this is meant as a non-limiting example; in some embodiments, computer systems include a plurality of processors. Further, each processor may include multiple caches of different levels (e.g., L1 cache, L2 cache, L3 cache, last-level cache (LLC), etc.). Some or all of the systems or methods described herein may be implemented on one or more of a plurality of processors or their respective caches. For example, a computer system consistent with the present disclosure may include a motherboard with 2 processors, each with 3 levels of cache and its own memory access monitoring logic.

Additionally, reference is made throughout this disclosure to a variety of “bits,” often as status indicators for various components of the present disclosure. While reference may be made to certain bit values indicating certain statuses, (e.g., a validity bit of “1” may imply that a cache line is valid, while a validity bit of “0” may imply the cache line is invalid), this is meant as a non-limiting example; embodiments wherein different values imply the same status are fully considered herein. For example, a validity bit of “0” may instead imply that a cache line is valid, while a validity bit of “1” may imply that the cache line is invalid, etc.

FIG. 1 illustrates an example computer system 100 according to several embodiments of the present disclosure. The system 100 generally includes at least processor 102 and memory 114. System 100 may additionally include various common components of computer systems such as a power supply, network interface, etc., but these are not shown in FIG. 1 in the interest of brevity. Processor 102 is configured to execute instructions associated with a plurality of processes 104a-104n (collectively “processes 104”) within software stack 103. Software stack 103 may also include system software such as an operating system (OS) or a virtual machine manager (VMM) of computer system 100. Memory 114 includes a plurality of memory addresses 116a-116n (collectively “memory addresses 116”) configured to store information, instructions, etc. Processor 102 is generally configured to access the information stored in memory addresses 116a of memory 114, e.g., during the course of executing instructions associated with processes 104. In typical configurations, when information is accessed from one of memory addresses 116, processor 102 stores the information in cache 108.

Cache 108 includes a plurality of cache sets 110a-110n (collectively “sets 110”). Each cache set includes a plurality of cache lines 112 (e.g., cache set 110a includes cache lines 112a.a-112a.n, cache set 112n includes cache lines 112n.a-112n.n, etc.; collectively “cache lines 112”). Each cache line generally includes a sequence of bits, each bit conveying a particular meaning depending upon its value (e.g., “1” or “0”) and its index in the sequence (e.g., a first bit may indicate a validity of the cache line, a second bit may indicate whether the cache line is dirty, etc.), as will be described in further detail below.

When processor 102 reads information from a memory address 116, the processor stores, writes, or otherwise records the information in one of cache lines 112. Processor 102 may select one of cache lines 112 based on any of a plurality of cache replacement policies (e.g., first-in-first-out (FIFO), last-recently used (LRU), etc.) implemented in processor 102 (not shown in FIG. 1). When processor 102 stores information to a cache line, a “valid” bit is set to “1” to indicate that the line includes valid data.

Memory access monitoring logic 106 (frequently referred to herein as “logic 106”) is generally configured to monitor various memory access operations instructed by processes 104 to be executed by processor 102. Logic 106 is further generally configured to detect, based at least on the memory access operations, whether a cache-based side-channel attack may be occurring. The type of monitoring may vary depending upon embodiment. For example, in some embodiments, this detection may be a probabilistic evaluation (e.g., logic 106 may determine with a certain confidence (e.g., 80%) that one of processes 104 is or is controlled by a malicious attacker). In some embodiments, logic 108 may perform a binary determination (e.g., determine or predict whether an attack is occurring). In some embodiments, logic 106 may monitor operations between different levels of a shared cache (e.g., between level 2 and level 3 caches of processor 102).

Logic 106 may monitor operations in accordance with one of a plurality of security policies. The security policies may be stored, for example, on memory 114, on processor memory (not shown in FIG. 1), in a register, etc. The security policies may outline, for example, if any specific processes are to be monitored, a kind of attack to monitor for, a pattern of memory accesses that may indicate an attack, what kind of attack various memory access patterns indicate, a sensitivity value (indicating, for example, a confidence threshold, wherein if logic 106 determines that an attack has a likelihood above the threshold, logic 106 is to implement mitigation measures), etc. In some embodiments, logic 106 may only include a single security policy (set in place by, for example, an original equipment manufacturer (OEM) of processor 102). In other embodiments, logic 106 may be subject to a plurality of security policies.

In some embodiments, logic 106 may be subject to more than one security policy at a given time. For example, different security policies may outline different memory access patterns as being indicative of different attacks, or different mitigation means, etc. Security policies may be loaded by an OEM or added by a user. This may require conflict avoidance or conflict resolution measures in order to prevent logic 106 from being subject to contradictory instructions. As a non-limiting example, if two security policies outline the same memory access pattern as indicating different attacks, each attack with its own corresponding mitigation method, logic 106 may defer to the security policy that has been active for the longest time.

Depending upon embodiment, it may be possible for security policies to be changed. For example, in some embodiments security policies may be changed at any time by a user. In some embodiments, security policies may be changed automatically depending upon, for example, throughput requirements, whether any of processes 104 have been identified as possibly malicious, etc. Combinations of the above are also possible; for example, in some embodiments, security policies may not be changed by users but may change automatically, or vice versa.

As a non-limiting example, under a first security policy logic 106 is configured to monitor process scheduling and memory access instructions to note which processes are scheduled whenever CLFLUSH (and associated variants thereof, such as CLFLUSHOPT, etc.) instructions are called or cache line flushes are requested. This enables logic 106 to detect repeated use of various flushes whenever a particular Ring 3 process (e.g., a possible victim or attacker application) is scheduled. “Repeated” in this context may include, for example, an instruction being detected every time the particular Ring 3 process is scheduled, an instruction being detected based on a threshold frequency (e.g., more than 95% of the time when the process is scheduled), based on a “usual” frequency (e.g., the instruction is detected twice as often when the process is scheduled than when the process is not scheduled), etc.

As an additional non-limiting example, under a second security policy logic 106 is configured to determine, upon detecting an explicit cache line flush instruction (e.g., an instruction explicitly outlining which lines of cache 108 to flush) whether the cache lines are associated with a critical data structure, such as a shared crypto-library (e.g., a secure sockets layer (SSL) library). Under this second policy, logic 106 is not necessarily configured to analyze memory access patterns or instructions; instead, logic 106 may simply prevent the flushing attempts. However, as described above, in some embodiments multiple policies may be active at the same time; thus, even if this second policy is active, logic 106 may still be configured to monitor memory accesses for patterns etc., as other attacks are still possible.

As an additional non-limiting example, under a third security policy logic 106 is configured to monitor or track processes 104 that flush specific cache lines. Further, logic 106 implementing this policy is configured to determine whether a process is accessing a cache line (or subset of cache lines) that the process has previously flushed. For example, if process 104a flushes cache lines 112a.a-112a.c, logic 106 will record this in, e.g., processor memory, memory 114, etc. To conserve space, logic 106 may store this flushed cache line information in a Bloom filter data structure with O(k) lookup (e.g., with k hash functions) and zero probability of false negatives. If, after another process (e.g., a “victim process” such as process 104b) executes, process 104a later attempts to access lines 112a.a-112a.c, logic 106 will determine that process 104a has accessed cache lines that it previously flushed (a common sign of a FLUSH based side-channel attack). In response to detecting an attack consistent in such a way, logic 106 may perform any of a plurality of security actions or operations, including marking or flagging process 104a as malicious/compromised, preventing the access instructions from executing, informing an operating system (OS) or user, a combination of any or all of the above, etc.

As an additional non-limiting example, under a fourth security policy logic 106 is configured to determine whether a process is attempting to flush one or more shared memory cache lines that are not in the cache hierarchy (which may be because they have already been flushed recently). While this may rarely occur during normal operation, repeated occurrences may indicate an attempted FLUSH+FLUSH attack, as an attacker process may be attempting to time the flush operations to determine which shared cache lines have been reloaded since the initial flush. Thus, under the fourth security policy, logic 106 may be configured to compare a number or frequency of attempts to flush a line that is not currently in the cache hierarchy to a threshold. The threshold may be preset, or may be determined and updated based on historical data. Example thresholds include 10 requests within 100 clock cycles, 20 requests from the same process within 30 operations, etc.

As an additional non-limiting example, under a fifth security policy logic 106 is configured to determine whether a process is sequentially loading and flushing cache lines belonging to adjacent or alternating memory rows in memory 114. This could indicate a possible “row hammer” attack, wherein an attacker process exploits physical properties of memory storage techniques to corrupt stored data. More particularly, writing information to physical memory address 116a can have a minor impact on a charge at memory address 116b. The change in charge may depend on, among other things, the information stored in address 116b or the electrical operations performed on address 116a. Thus, an attacker may be able to corrupt or modify information in address 116b without directly accessing the address. This may be useful for an attacker if, for example, the attacker does not have access or permission to read address 116b but is able to flip a privilege bit (thus granting the attacker access it should not have).

Therefore, a process sequentially loading and flushing cache lines belonging to alternating memory rows (e.g., cache lines 112a.a, 112a.c and 112a.e if they correspond to memory addresses 116a, 116c and 116e) may be attempting a row hammer attack. Logic 106 may communicate with a memory management unit (not shown in FIG. 1) in order to determine adjacency of memory addresses.

In some embodiments, logic 106 may implement one or more intelligent security policies, including machine learning, probabilistic modeling, etc. As a non-limiting example, logic 106 operating under a first intelligent security policy assumes CLFLUSH occurrences follow a Markov process with the assumption that:

P(X(t)∈A|X(t₁)=x₁, . . . ,X(tₙ)=xₙ}=P(X(t)∈A|X(tₙ)=xₙ},

wherein P(X(t)), the probability P of a CLFLUSH instruction X occurring at time t, is the same whether conditioned on both the past and present (A|X(t₁) . . . X(tₙ)) or just on the present (A|X(tₙ)). Under this first intelligent security policy, logic 106 is configured to model occurrence of CLFLUSH as a continuous time process counting rare events (CLFLUSH operations) with the following properties:

1. P{X(t+h)−X(t)=1}=P(one FLUSH in [t,t+h])=λh+o(h), as h→0

2. P{X(t+h)−X(t)>1}=P(more than one FLUSH in [t,t+h])=o(h), as h→0

3. For t₁<t₂<t₃<t₄<t₀ (X(t₂)−X(t₁)) and (X(t₄)−X(t₃)) are independent.

In essence, the probability that a single flush will occur within the next h amount of time is represented as λh+o(h) as h approaches zero, where the parameter λ represents the expected frequency of events. For example, h and t may be measured in seconds while λ is an expected number of flushes per second. Little-o “o(h)” implies that probability P approaches zero much more quickly than h does. As CLFLUSH (and similar) operations are generally rare events in modern computing systems, the probability that more than one flush operation will occur in the same amount of time is simply o(h) as h approaches zero.

In some embodiments, λ may be set by, for example, an original equipment manufacturer (OEM). Example values of λ include, for example, 1 CLFLUSH/minute, 100 CLFLUSHes/minute, etc. In some embodiments, λ may be determined by logic 106 during a model fitting process. In general, logic 106 may approximate CLFLUSH occurrences as a Poisson counting process. As such, the periods of time between various counts of CLFLUSH events (the “inter-arrival times”) can be approximated by an exponential distribution.

For example, over a given period of time divided into equal intervals, intervals wherein no CLFLUSH event occurred may have a density of 0.7, while intervals with a single CLFLUSH event may have a density of 0.2, implying that any given interval is 0.7/0.2=3.5 times more likely to be devoid of CLFLUSH events than to include a single event. Further, intervals with two CLFLUSH events may have a density of 0.06, implying that an interval is similarly approximately 3.5 times more likely to include a single CLFLUSH event than it is to include two CLFLUSH events, implying a mean of 3.5, making λ=1/3.5 ≈0.286. In the same example, any given interval is 0.7/0.06 ≈11.67 times more likely to include no CLFLUSH events than two CLFLUSH events. Expanding upon this, an interval including n CLFLUSH events has a density of (1/λ)ⁿ relative to an interval including no CLFLUSH events. In this example, logic 106 monitors for CLFLUSH events over more and more intervals, expecting occurrences to fall within this exponential distribution. Logic 106 may compare measured events to expected via, for example, root-mean-square (RMS) error analysis. If CLFLUSH events occur more often than expected (for example, if intervals including three CLFLUSH events become as common as intervals including no CLFLUSH events), logic 106 determines that a side-channel attack is likely occurring.

During the model fitting process, logic 106 may determine λ by first monitoring processor operations for CLFLUSH events over a preset period (e.g., for a certain amount of time, for a certain number of operations, until a certain number of CLFLUSH events have occurred, etc.). Logic 106 divides the measurement period into intervals such that the density of CLFLUSH events in each interval follows an exponential distribution. Logic 106 then iterates through multiple candidate values for k. For example, initial candidate k values may be 0.01, 0.02 . . . 0.99. For each candidate k, logic 106 determines expected density and compares the expected density to the observed data by determining the error (e.g., RMS error) between the two. If at least one candidate λ has an error below a preset threshold (e.g., 0.05, 0.01, etc.), logic 106 selects the λ corresponding to the lowest error. If no candidate λ has a satisfactory error, logic 106 may attempt additional values. For example, logic 106 may increase the resolution of candidate λ values (e.g., 0.001, 0.002, . . . 0.999). In some embodiments, logic 106 may consider λ values near the previous candidate with the lowest error (even if it was unsatisfactory). For example, if k=0.32 resulted in the lowest error during an initial pass, logic 106 may consider 0.3101, 0.3102, . . . 0.3299. If logic 106 is still unable to find a λ with a satisfactory error, logic 106 may select the λ with the lowest error (regardless of its unsatisfactory error), resume monitoring to expand (or, in some embodiments, replace) the collected dataset and try again, report an error, or select a default λ.

Once logic 106 has determined λ, logic 106 monitors for occurrence of CLFLUSH events and determines probability that a CLFLUSH event will occur for given intervals based on the parameters of equations 1-4 and the determined value of λ. As λ defines a density function, logic 106 determines the probability based on the integral of the density function. If a CLFLUSH event occurs when the estimated probability is below a threshold (e.g., estimated probability <0.05), logic 106 determines that an anomaly has occurred, possibly indicating a side-channel attack. Depending upon embodiment, the threshold may be set by an OEM, a user, or either an OEM or a user. In some embodiments the threshold may be adjusted by the user, for example through a user interface.

As an additional non-limiting example, logic 106 operating in accordance with a second intelligent security policy consistent with the present disclosure is configured to utilize machine learning classification to detect side-channel attacks. In this example, logic 106 is configured to model occurrence of instructions such as CLFLUSH as a sequence (e.g., an n-gram). Logic 106 is configured to then utilize output of the n-gram analysis as input to a classifier. The classifier may implement any of a plurality of machine learning methodologies including, for example, random forest, support vector machine (SVM), linear discriminant analysis, k nearest neighbor, etc. In some embodiments, logic 106 may initially utilize multiple classifiers, determine one or more performance metrics for each classifier and, depending upon results of training, select a classifier having the best performance metrics. Performance metrics measured by logic 106 may include, for example, accuracy, number of false positives, number of false negatives, etc.

Logic 106 may train a classifier by first collecting sequences of instructions issued in processor 102. As described herein, instructions may be collected by logic 106. Logic 106 then uses n-gram modeling to extract sequential features which capture the ordering of the instructions. Logic 106 may divide collected sequences of instructions into a training set and a testing set. The distribution between training and testing sets may vary. For example, logic 106 may utilize 90% of the sequences for training with the remaining 10% for testing, or the distribution may be 80%/20% training/testing, respectively, 75%/25% training/testing, etc. Logic 106 may utilize the training set to train the machine learning classifier according to methods known to those skilled in the art. Logic 106 then evaluates performance of the classifier on the test data. In some embodiments, logic 106 may adjust parameters of the classifier (node sensitivities, etc.) depending upon accuracy, false positives, false negatives, etc. In some embodiments, logic 106 may train a plurality of classifiers and select one of the plurality for use based on associated performance metrics.

Upon detecting a possible cache timing side-channel attack, logic 106 is generally configured to perform one of a plurality of possible security operations. For example, in some embodiments, logic 106 may be configured to set one or more bits of a control register such as CR4 to indicate one of a plurality of cache security policies as “active.” This cache security policy may result in processor 102 performing various hardware or software security operations such as flushing cache lines, etc.

In some embodiments, CLFLUSH operations originating from a Ring 3 process may be trapped to indicate that logic 106 is to analyze them (e.g., using heuristics or machine learning based methods as described herein). If logic 106 determines that a pattern of CLFLUSH instructions originating from a Ring 3 process likely indicate a side-channel attack, logic 106 may indicate this (e.g., via a tag) to Ring 0 software such as the operating system (OS), virtual machine manager (VMM), etc. The Ring 0 software may then determine whether to execute the flush instructions (e.g., based on its own security policy). In some embodiments, the Ring 0 software blocks execution of flush operations that logic 106 reports as untrustworthy (e.g., as likely part of a side-channel attack).

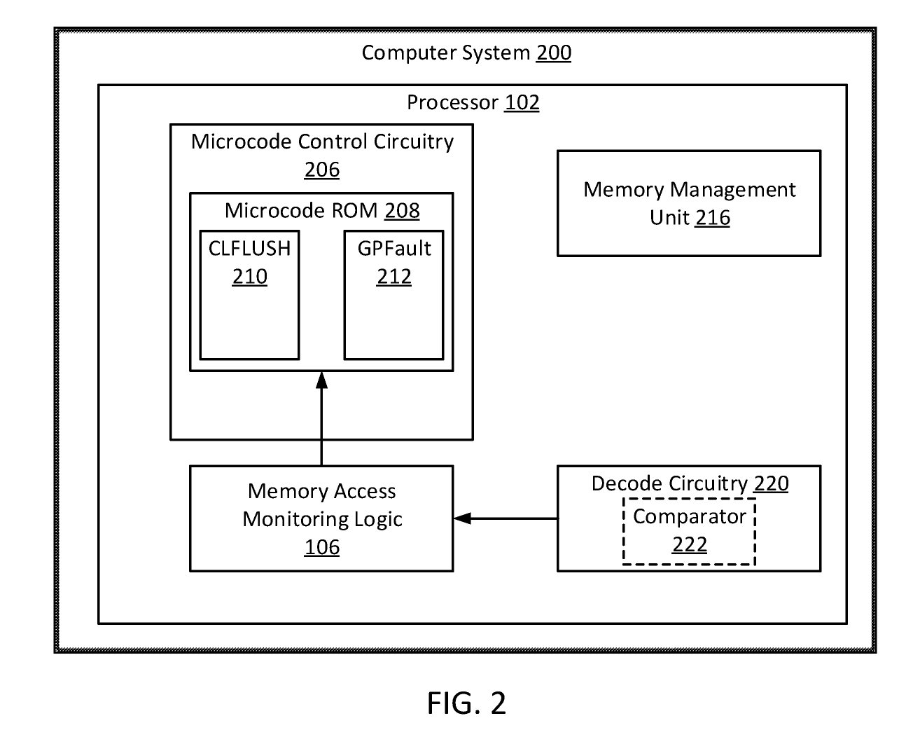

FIG. 2 illustrates an example computer system 200 according to several embodiments of the present disclosure. In particular, FIG. 2 depicts components of processor 102 such as microcode control circuitry 206, memory management unit (MMU) 216 and decode circuitry 220. Additional components may be included within processor 102 (e.g., instruction fetch circuitry, bus interface circuitry, floating point circuitry, address generation circuitry, etc.) but are omitted for the purpose of brevity.

Microcode control circuitry 206 includes at least microcode read-only memory (ROM) 208, having stored thereon definitions (e.g., of instructions such as CLFLUSH 210 or interrupt handler routines such as GPFault 212). Control circuitry 206 also generally include memory access monitoring logic 106 configured to perform security determinations as described herein.

When an instruction is decoded and executed, the specific operations to be carried out by processor 102 are looked up in microcode ROM 208. For example, when a process (e.g., process 104a) attempts a CLFLUSH instruction during operation, the instruction is fetched (e.g., via bus interface circuitry and/or instruction fetch circuitry, not shown in FIG. 2). The instruction is decoded by decode circuitry 220 to determine which instruction is to be executed; in this example, CLFLUSH 210.

Thus, microcode control circuitry 206 accesses microcode ROM 208 to determine operations to execute in order for processor 102 to carry out the CLFLUSH instruction 210. In some embodiments, CLFLUSH 210 is configured to be trapped such that logic 106 may determine or otherwise analyze whether the instruction comprises a security risk or a possible side-channel attack. If logic 106 determines that the instruction is a part of a side-channel attack, logic 106 may adjust or modify a control register (e.g., one or more previously reserved bits of CR4) to activate a security policy such that only a ring 0 process may cause the instruction to be executed. If logic 106 does not determine that the instruction is a part of a side-channel attack, processor 102 may carry out the CLFLUSH instruction.

In some embodiments, decode circuitry 220 may include a comparator 222 to compare an instruction privilege level to a current privilege level (i.e., of the process requesting the instruction). If the privilege levels do not match (e.g., if the process does not have the required privilege level), the instruction may be trapped such that logic 106 may initiate monitoring (e.g., via the heuristic or machine learning methods described herein). CLFLUSH may require a privilege level of, for example, ring 0.

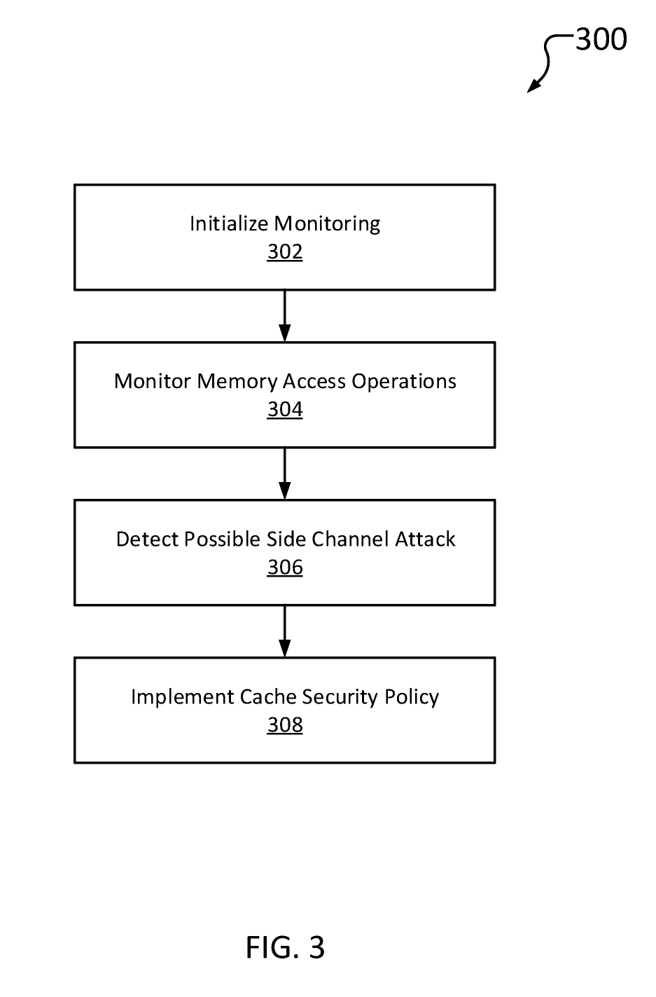

FIG. 3 illustrates operations 300 according to one embodiment of the present disclosure. Operations according to this embodiment include initializing monitoring operations 302. This may include, for example, a CLFLUSH operation being trapped due to the stored microcode as described herein, due to a failed privilege check performed by a comparator of decoder circuitry, etc. Operations further include monitoring memory access patterns 304. This may comprise, for example, memory access monitoring logic 106 monitoring accesses of cache 108 or memory 114 by one or more processes 104. As described herein, logic 106 may monitor memory access operations according to one of a plurality of security policies. Operations further include detecting a possible side-channel attack 306. This may include, for example, logic 106 determining that a flush instruction initiated by a process violates an active security policy. Operations according to this embodiment also include implementing a cache security policy 308. This may include, for example, logic 106 flagging the process attempting the operations as suspicious/untrustworthy, modifying one or more control register bits, etc.

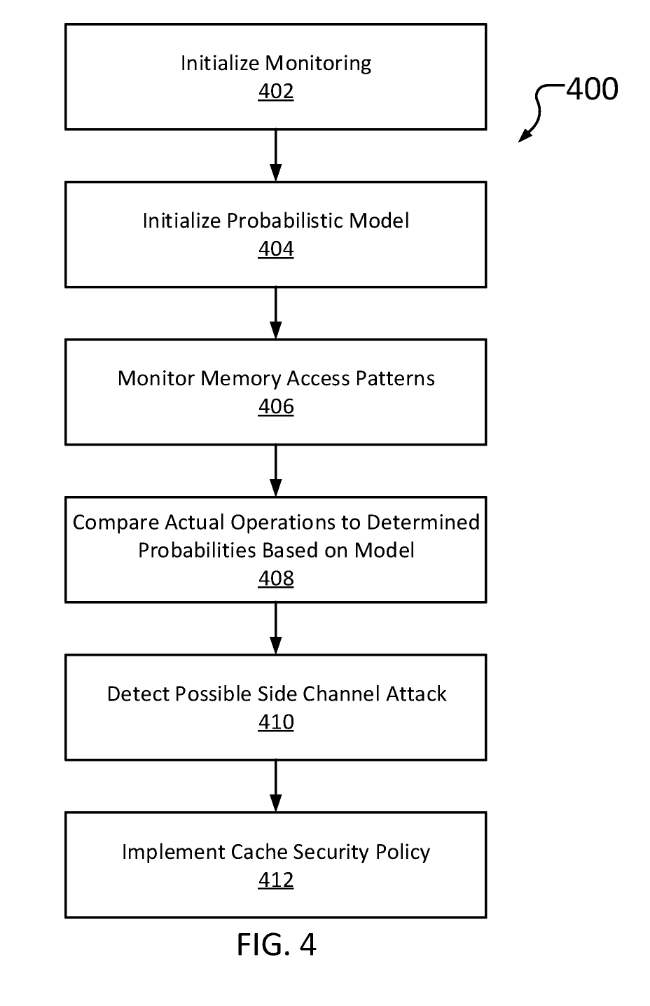

FIG. 4 illustrates operations 400 according to one embodiment of the present disclosure. Operations according to this embodiment include initializing monitoring operations 402. This may include, for example, a CLFLUSH operation being trapped due to the stored microcode as described herein, due to a failed privilege check performed by a comparator of decoder circuitry, etc. Operations further include initializing a probabilistic model 404. This may include, for example, logic 106 determining a λ based on a training set to implement an intelligent security policy that assumes CLFLUSH occurrences follow a Markov process, enabling logic 106 to determine probabilities of various operations (e.g., CLFLUSH). Operations also include monitoring memory access patterns 406. This may include, for example, logic 106 monitoring accesses of cache 108 or memory 114 by one or more processes 104, as with 304. Logic 106 may further input the memory access operations to the probabilistic model. Operations additionally include comparing actual operations to determined probabilities based on the model 408. This may include, for example, logic 106 determining whether monitored operations are anomalous relative to the probabilistic model. Operations further include detecting a possible side-channel attack 410. For example, as described herein, if logic 106 determines that a CLFLUSH operation is requested by a process despite logic 106 determining that a CLFLUSH operation has less than a 5% probability of being requested, logic 106 may determine that the operation is likely part of a side-channel attack. Operations also include implementing a cache security policy 412. For example, logic 106 may flag or tag the responsible process as untrusted, compromised, malicious, or otherwise insecure. Logic 106 may additionally or alternatively modify one or more bits of a control register such as CR4 to indicate that malicious activity is occurring.

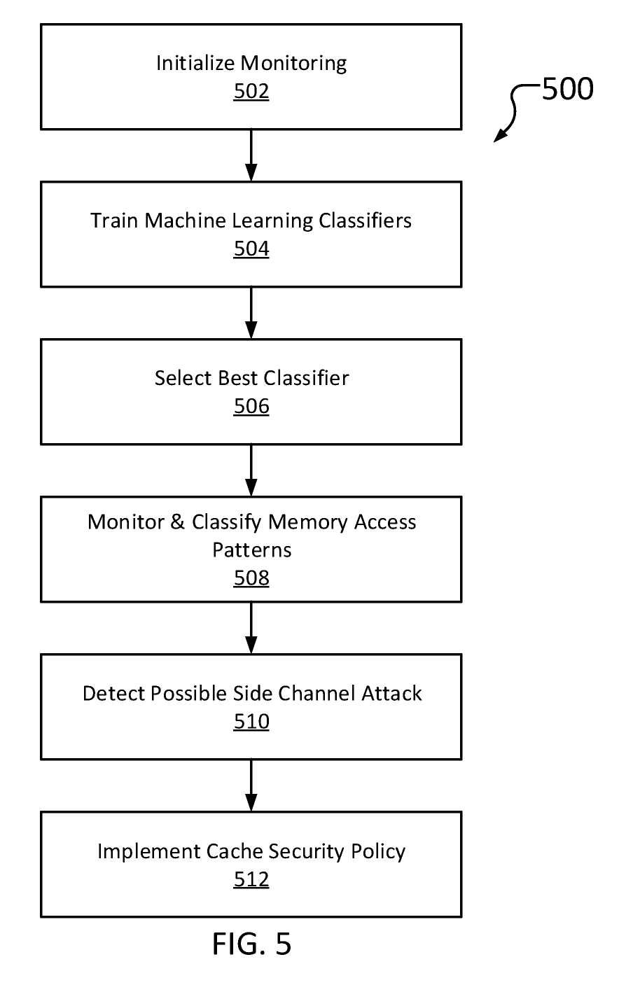

FIG. 5 illustrates operations 500 according to one embodiment of the present disclosure. Operations according to this embodiment include initializing monitoring operations 502. This may include, for example, a CLFLUSH operation being trapped due to the stored microcode as described herein, due to a failed privilege check performed by a comparator of decoder circuitry, etc. Operations further include training one or more machine learning classifiers 504. This may be performed by, for example, logic 106 as described herein. Operations further include selecting a “best” classifier 506. This may include, for example, logic 106 comparing results of the one or more trained classifier against a test data set and selecting one classifier based on one or more performance metrics, such as fewest false negatives, fewest false positives, highest overall accuracy, etc. As described herein, in some embodiments logic 106 may retrain some or all of the classifiers if no classifier results in satisfactory performance metrics. Operations additionally include monitoring and classifying memory access patterns 508. This may include, for example, logic 106 monitoring accesses of cache 108 or memory 114 by one or more processes 104, as with 304 or 406. In addition, logic 106 may input information corresponding to the accesses into the classifier and receive an output representing whether or not the accesses comprise a possible security threat (e.g., a side-channel attack). Operations also include detecting a possible side-channel attack 510. For example, logic 106 may rely upon output of the classifier to determine whether given access operations are “suspicious,” i.e., likely comprise part of a side-channel attack. Operations further include implementing a cache security policy 512. This may include, for example, logic 106 flagging the process requesting execution of the suspicious instructions, modifying one or more control register bits, etc.

Operations for the embodiments have been described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to systems and methods for preventing or mitigating the effects of a cache-timing based side-channel attack, such as a FLUSH+RELOAD attack, a FLUSH+FLUSH attack, a Meltdown or Spectre attack, etc.

The terms and expressions which have been employed herein are used as terms of description and not of limitation, and there is no intention in the use of such terms and expressions of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in any embodiment herein, the term “logic” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The logic may, collectively or individually, be embodied as circuitry that forms part of a larger system, for example, an integrated circuit (IC), system on-chip (SoC), desktop computers, laptop computers, tablet computers, servers, smartphones, etc.

The following examples pertain to further embodiments. The following examples of the present disclosure may comprise subject material such as at least one device, a method, at least one machine-readable medium for storing instructions that when executed cause a machine to perform acts based on the method and/or means for performing acts based on the method.

According to example 1, there is provided a computing system. The computing system may comprise memory circuitry, processor circuitry to execute instructions associated with a plurality of processes, the processor circuitry having at least a cache including at least a plurality of cache lines to store information from the memory circuitry, and memory access monitoring logic to monitor memory access operations associated with at least one of the processes, determine, based on an active security policy, whether the memory access operations correspond to a side-channel attack, and responsive to a determination that the memory access operations correspond to a side-channel attack, implement a cache security policy.

Example 2 may include the elements of example 1, wherein the memory access monitoring logic to, responsive to a determination that the memory access operations correspond to a side-channel attack, implement a cache security policy comprises memory access monitoring logic to, responsive to a determination that the memory access operations correspond to a side-channel attack, determine which of the plurality of processes correspond to the memory access operations that correspond to the side-channel attack, and indicate that the determined process is an untrusted process.

Example 3 may include the elements of any of examples 1-2, further comprising microcode control circuitry to trap the memory access operations such that only processes associate with a higher privilege level may cause the processor to execute the memory access operations.

Example 4 may include the elements of any of examples 1-3, wherein the memory access monitoring logic to determine, based on an active security policy, whether the memory access operations correspond to a side-channel attack comprises memory access monitoring logic to initialize a probabilistic model, monitor memory access operations associated with at least one of the processes, input the memory access operations to the model, and determine, based on an output of the model, whether the memory access operations correspond to a side-channel attack.

Example 5 may include the elements of any of examples 1-4, wherein the memory access monitoring logic to monitor memory access operations associated with at least one of the processes comprises memory access monitoring logic to receive a first set of memory access operations, train a machine learning classifier based on the first set, and monitor a second set of memory access operations associated with at least one of the processes.

Example 6 may include the elements of example 5, wherein the memory access monitoring logic to determine, based on an active security policy, whether the memory access operations correspond to a side-channel attack comprises memory access monitoring logic to input the second set of memory access operations to the classifier, generate an output from the classifier based on the second set, and determine, based on the output, whether the memory access operations correspond to a side-channel attack.

Example 7 may include the elements of any of examples 1-6, wherein the memory access monitoring logic further includes a security policy register comprising one or more bits to indicate the active security policy, and the memory access monitoring logic is further to determine, based on contents of the security policy register, which of a plurality of security policies is active.

Example 8 may include the elements of any of examples 1-7, wherein the memory access operations comprise CLFLUSH operations.

According to example 9 there is provided a method. The method may comprise monitoring, via memory access monitoring logic, memory access operations associated with at least one of a plurality of processes to be executed by a processor, determining, via the memory access monitoring logic based on an active security policy, whether the memory access operations correspond to a side-channel attack, and, responsive to a determination that the memory access operations correspond to a side-channel attack, implementing, via the memory access monitoring logic, a cache security policy.

Example 10 may include the elements of example 9, wherein the implementing, via the memory access monitoring logic, a cache security policy comprises, responsive to a determination that the memory access operations correspond to a side-channel attack, determining, via the memory access monitoring logic, which of the plurality of processes correspond to the memory access operations that correspond to the side-channel attack, and indicating, via the memory access monitoring logic, that the determined process is an untrusted process.

Example 11 may include the elements of any of examples 9-10, further comprising trapping, via microcode control circuitry, the memory access operations such that only processes associate with a higher privilege level may cause the processor to execute the memory access operations.

Example 12 may include the elements of any of examples 9-11, wherein the determining, via the memory access monitoring logic based on an active security policy, whether the memory access operations correspond to a side-channel attack comprises initializing, via the memory access monitoring logic, a probabilistic model, monitoring, via the memory access monitoring logic, memory access operations associated with at least one of the processes, inputting, via the memory access monitoring logic, the memory access operations to the model, and determining, via the memory access monitoring logic based on an output of the model, whether the memory access operations correspond to a side-channel attack.

Example 13 may include the elements of any of examples 1-2, wherein the monitoring, via memory access monitoring logic, memory access operations associated with at least one of a plurality of processes comprises receiving, via the memory access monitoring logic, a first set of memory access operations, training, via the memory access monitoring logic, a machine learning classifier based on the first set, and monitoring, via the memory access monitoring logic, a second set of memory access operations associated with at least one of the processes.

Example 14 may include the elements of example 13, wherein the determining, via the memory access monitoring logic based on an active security policy, whether the memory access operations correspond to a side-channel attack comprises inputting, via the memory access monitoring logic, the second set of memory access operations to the classifier, generating, via the memory access monitoring logic, an output from the classifier based on the second set, and determining, via the memory access monitoring logic based on the output, whether the memory access operations correspond to a side-channel attack.

Example 15 may include the elements of any of examples 9-14, further comprising determining, via the memory access monitoring logic based on contents of a security policy register, which of a plurality of security policies is active.

Example 16 may include the elements of any of examples 9-15, wherein the memory access operations comprise CLFLUSH operations.

According to example 17 there is provided a system including at least one device, the system being arranged to perform the method of any of the above examples 9-16.

According to example 18 there is provided a chipset arranged to perform the method of any of the above examples 9-16.

According to example 19 there is provided at least one machine readable storage device have a plurality of instructions stored thereon which, when executed on a computing device, cause the computing device to carry out the method according to any of the above examples 9-16.

What is claimed:

1. A computing system, comprising:
memory circuitry;
processor circuitry to execute instructions associated with a plurality of processes, the processor circuitry having at least:
a cache including at least a plurality of cache lines to store information from the memory circuitry; and
memory access monitoring logic to:
monitor memory access operations associated with at least one of the processes;
determine, based on an active security policy, whether the memory access operations correspond to a side-channel attack; and
responsive to a determination that the memory access operations correspond to a side-channel attack, implement a cache security policy.

2. The computing system of claim 1, wherein the memory access monitoring logic to, responsive to a determination that the memory access operations correspond to a side-channel attack, implement a cache security policy comprises memory access monitoring logic to, responsive to a determination that the memory access operations correspond to a side-channel attack:
determine which of the plurality of processes correspond to the memory access operations that correspond to the side-channel attack; and
indicate that the determined process is an untrusted process.

3. The computing system of claim 1, further comprising microcode control circuitry to trap the memory access operations such that only processes associate with a higher privilege level may cause the processor to execute the memory access operations.

4. The computing system of claim 1, wherein the memory access monitoring logic to determine, based on an active security policy, whether the memory access operations correspond to a side-channel attack comprises memory access monitoring logic to:
initialize a probabilistic model;
monitor memory access operations associated with at least one of the processes;
input the memory access operations to the model; and
determine, based on an output of the model, whether the memory access operations correspond to a side-channel attack.

5. The computing system of claim 1, wherein the memory access monitoring logic to monitor memory access operations associated with at least one of the processes comprises memory access monitoring logic to:
receive a first set of memory access operations;
train a machine learning classifier based on the first set; and
monitor a second set of memory access operations associated with at least one of the processes.

6. The computing system of claim 5, wherein the memory access monitoring logic to determine, based on an active security policy, whether the memory access operations correspond to a side-channel attack comprises memory access monitoring logic to:
input the second set of memory access operations to the classifier;
generate an output from the classifier based on the second set; and
determine, based on the output, whether the memory access operations correspond to a side-channel attack.

7. The computing system of claim 1, wherein:
the memory access monitoring logic further includes a security policy register comprising one or more bits to indicate the active security policy; and
the memory access monitoring logic is further to determine, based on contents of the security policy register, which of a plurality of security policies is active.

8. The computing system of claim 1, wherein the memory access operations comprise CLFLUSH operations.

9. A method, comprising:
monitoring, via memory access monitoring logic, memory access operations associated with at least one of a plurality of processes to be executed by a processor;
determining, via the memory access monitoring logic based on an active security policy, whether the memory access operations correspond to a side-channel attack; and
responsive to a determination that the memory access operations correspond to a side-channel attack, implementing, via the memory access monitoring logic, a cache security policy.

10. The method of claim 9, wherein the implementing, via the memory access monitoring logic, a cache security policy comprises, responsive to a determination that the memory access operations correspond to a side-channel attack:
determining, via the memory access monitoring logic, which of the plurality of processes correspond to the memory access operations that correspond to the side-channel attack; and
indicating, via the memory access monitoring logic, that the determined process is an untrusted process.

11. The method of claim 9, further comprising trapping, via microcode control circuitry, the memory access operations such that only processes associate with a higher privilege level may cause the processor to execute the memory access operations.

12. The method of claim 9, wherein the determining, via the memory access monitoring logic based on an active security policy, whether the memory access operations correspond to a side-channel attack comprises:
initializing, via the memory access monitoring logic, a probabilistic model;
monitoring, via the memory access monitoring logic, memory access operations associated with at least one of the processes;
inputting, via the memory access monitoring logic, the memory access operations to the model; and
determining, via the memory access monitoring logic based on an output of the model, whether the memory access operations correspond to a side-channel attack.

13. The method of claim 9, wherein the monitoring, via memory access monitoring logic, memory access operations associated with at least one of a plurality of processes comprises:
receiving, via the memory access monitoring logic, a first set of memory access operations;
training, via the memory access monitoring logic, a machine learning classifier based on the first set; and
monitoring, via the memory access monitoring logic, a second set of memory access operations associated with at least one of the processes.

14. The method of claim 13, wherein the determining, via the memory access monitoring logic based on an active security policy, whether the memory access operations correspond to a side-channel attack comprises:
inputting, via the memory access monitoring logic, the second set of memory access operations to the classifier;
generating, via the memory access monitoring logic, an output from the classifier based on the second set; and
determining, via the memory access monitoring logic based on the output, whether the memory access operations correspond to a side-channel attack.

15. The method of claim 9, further comprising determining, via the memory access monitoring logic based on contents of a security policy register, which of a plurality of security policies is active.

16. The method of claim 9, wherein the memory access operations comprise CLFLUSH operations.

17. One or more non-transitory computer-readable storage devices having stored thereon instructions which, when executed by a processor, result in operations comprising:
monitor memory access operations associated with at least one of the processes;
determine, based on an active security policy, whether the memory access operations correspond to a side-channel attack; and
responsive to a determination that the memory access operations correspond to a side-channel attack, implement a cache security policy.

18. The one or more non-transitory computer-readable storage devices of claim 17, wherein the instructions which, when executed by the processor, result in the operations responsive to a determination that the memory access operations correspond to a side-channel attack, implement a cache security policy comprise instructions which, when executed by the processor, result in operations comprising, responsive to a determination that the memory access operations correspond to a side-channel attack:
determine which of the plurality of processes correspond to the memory access operations that correspond to the side-channel attack; and
indicate that the determined process is an untrusted process.

19. The one or more non-transitory computer-readable storage devices of claim 17, wherein the instructions comprise instructions which, when executed by the processor, result in operations comprising:
trap the memory access operations such that only processes associated with a higher privilege level may cause the processor to execute the memory access operations.

20. The one or more non-transitory computer-readable storage devices of claim 17, wherein the instructions which, when executed by the processor, result in the operations determine, based on an active security policy, whether the memory access operations correspond to a side-channel attack comprise instructions which, when executed by the processor, result in operations comprising:
initialize a probabilistic model;
monitor memory access operations associated with at least one of the processes;
input the memory access operations to the model; and
determine, based on an output of the model, whether the memory access operations correspond to a side-channel attack.

21. The one or more non-transitory computer-readable storage devices of claim 17, wherein the instructions which, when executed by the processor, result in the operations monitor memory access operations associated with at least one of the processes comprise instructions which, when executed by the processor, result in operations comprising:
receive a first set of memory access operations;
train a machine learning classifier based on the first set; and
monitor a second set of memory access operations associated with at least one of the processes.

22. The one or more non-transitory computer-readable storage devices of claim 21, wherein the instructions which, when executed by the processor, result in the operations determine, based on an active security policy, whether the memory access operations correspond to a side-channel attack comprise instructions which, when executed by the processor, result in operations comprising:
input the second set of memory access operations to the classifier;
generate an output from the classifier based on the second set; and
determine, based on the output, whether the memory access operations correspond to a side-channel attack.

23. The one or more non-transitory computer-readable storage devices of claim 17, wherein the instructions comprise instructions which, when executed by the processor, result in operations comprising:
determine, based on contents of a security policy register, which of a plurality of security policies is active.

24. The one or more non-transitory computer-readable storage devices of claim 17, wherein the memory access operations comprise CLFLUSH operations.
